(19) United States
(12) Patent Application Publication
(10) Pub. No.: US 2005/0064075 A1
(43) Pub. Date: Mar. 24, 2005

(54) Method for preserving food using metal-modified apatite and food container used therein

(76) Inventor: Masato Wakamura, Kanagawa (JP)

Correspondence Address: STAAS & HALSEY LLP, SUITE 700, 1201 NEW YORK AVENUE, N.W., WASHINGTON, DC, 20005, US

(21) Appl. No.: 10/500,448

(22) PCT Filed: Mar. 27, 2002
(86) PCT No.: PCT/JP02/03024

(51) Int. Cl. C12C 1/027

(52) U.S. Cl. 426/106

(57) ABSTRACT

A method for preserving food includes putting food in a container having an inner surface coated with a metal-modified apatite or in a container made of a material to which the metal-modified apatite is added, the metal-modified apatite having an apatite crystal structure including metal atoms partially comprising photocatalytic metal, and placing the container in a dark place at least temporarily.

### TECHNICAL FIELD

The present invention relates to a method for preserving food by utilizing antibacterial effect of a catalytic metal-modified apatite. It also relates to a food container used therefor.

### BACKGROUND ART

In a grocery market, processed food or fresh food is often put or packed in a container for trading. For example, part of fish or raw meet displayed at the food section of a supermarket may be packed in a polystyrene foam food container and covered with a wrapping film. A box lunch or prepared food sold at a convenience store may be contained in a container molded from polystyrene or polypropylene, for example.

Conventionally, such a container for food to be sold in a grocery store is cleaned and sterilized before food is put into the container for the purpose of preventing the contamination of food due to e.g. bacteria, and hence preventing the rapid progress of the putrefaction of food or the food poisoning. Usually, however, no measures have been taken to prevent the contamination of food which may occur in the environment after the food is contained in a container, or after the food is shipped or sold, for example. For this reason, food poisoning incidents often occur, particularly in summer, with respect to e.g. fresh food which is more likely to be affected by bacteria. Recently, therefore, for the enhanced assurance of food safety, there is a demand for the introduction of technique to prevent the pollution of food after the storage in a container.

As an example of such technique, it may be considered to make a container antibacterial by applying a conventional synthetic chemical for disinfection to the container. However, since the container is used for food storage, the use of such disinfectant is not practical when the disinfectant contains even a slight degree of toxicity to human. As another technique, the application of a natural antibacterial substance extracted from e.g. a Japanese cypress or a Japanese horseradish to a container is known. However, since the antibacterial substance is effective for suppressing the growth of germ, not for sterilization, this method is considered to be insufficient for preventing the progress of the food putrefaction or the food poisoning.

Recently, attention is being focused on a photocatalytic function of some semiconductor materials such as titanium oxide (TiO₂), and it is also known that this function can provide antibacterial effect. Generally, in a semiconductor material such as titanium oxide having a photocatalytic function, electrons in a valence band move into a conduction band by absorbing light having the energy corresponding to the band gap between the valence band the conduction band, leaving holes in the valence band. The electrons in the conduction band tend to move to a substance adsorbed to the surface of the semiconductor material to reduce the adsorbed substance. The holes formed in the valence band tend to take electrons from the substance adsorbed to the surface of the semiconductor material to oxidize the adsorbed substance.

In titanium oxide (TiO₂), the oxidizing force of the holes formed in the valence band is very strong. Therefore, when an organic substance, for example, is adsorbed to titanium oxide, the organic substance may be eventually decomposed into water and carbon dioxide. Among the semiconductor materials having the photocatalytic effect, titanium oxide particularly serves as a good catalyst for such oxidative decomposition of organic substances and is therefore widely used in an antibacterial agent, deodorant, or environmental cleaning agent, for example.

However, titanium oxide itself can exhibit the function as a catalyst by absorbing light. Therefore, even when titanium oxide is applied to a food container as an antibacterial agent, the antibacterial action due to the photocatalytic effect cannot be expected if the food or the container is stored in a dark place, because titanium oxide cannot absorb light sufficiently in such a dark place. Therefore, the antibacterial action based on the photocatalytic effect of titanium oxide itself is not effective for food or a container which can be stored in a dark place for a relatively long period in the distribution process.

Moreover, titanium oxide itself has a poor ability to adsorb substances to its surface, i.e. low adsorptivity. Conceivably, therefore, to sufficiently effect the catalytic function of titanium oxide, the contact efficiency between the objective substance to be subjected to oxidative decomposition and titanium oxide need be improved for the purpose of enhancing the apparent adsorptivity of titanium oxide.

### DISCLOSURE OF THE INVENTION

An object of the present invention, which is conceived under the circumstances described above, is to eliminate or lessen the prior art problems described above, and to provide a food storage method which can provide good antibacterial effect both under conditions with light irradiation and in a dark place, and to provide a food container used therefor.

According to a first aspect of the present invention, there is provided a method for preserving food comprising: putting food in a container having an inner surface coated with a metal-modified apatite or in a container made of a material to which the metal-modified apatite is added, the metal-modified apatite having an apatite crystal structure including metal atoms partially comprising photocatalytic metal; and placing the container in a dark place at least temporarily.

The apatite constituting the main skeleton of the metal-modified apatite used in the present invention can be expressed by the following general formula:
Aₓ(BO_{y})_{z}Xₛ (1)

In the formula (1), the symbol A represents a metal atom such as Ca, Co, Ni, Cu, Al, La, Cr, Fe or Mg, for example. The symbol B represents an atom such as P or S, for example. The symbol X is a hydroxyl group (—OH) or a halogen atom (such as F or Cl), for example. Specifically, examples of apatite include hydroxyapatite, fluoroapatite, chloroapatite, tribasic calcium phosphate and calcium monohydrogenphosphate. The apatite suitable for use in the present invention is hydroxyapatite, wherein the symbol X in the above formula is a hydroxyl group (—OH). More preferably, the apatite is calcium hydroxyapatite (hereinafter described as “CaHAP”), or Ca₁₀(PO₄)₆(OH)₂) wherein the symbol A in the above formula is calcium (Ca), B is phosphorus (P), and X is a hydroxyl group (—OH).

Calcium hydroxyapatite or (Ca₁₀(PO₄)₆(OH)₂) is a main component of hard tissues such as teeth or bones and widely used as a medical material for artificial bones, artificial tooth roots or artificial organs, for example. CaHAP is highly adsorptive due to its liability to undergo the ion exchange with cation as well as with anion, and particularly known for its high ability to adsorb organic substances such as protein. Therefore, studies have been carried out of the techniques to apply CaHAP to a wide field such as chromatography adsorbents, chemical sensors or ion exchangers, for example. Moreover, since CaHAP can strongly adsorb and deactivate bacteria and viruses, it has been utilized also as an antibacterial agent. However, the antibacterial effect of CaHAP is based on its adsorptivity and is not to decompose bacteria or viruses.

The “photocatalytic metal” in the present invention means a metal atom which can serve as the photocatalytic center in the oxide state, and examples of such photocatalytic metal include titanium (Ti), zirconium (Zr), iron (Fe) and tungsten (W). It is considered that, when the photocatalytic metal is incorporated into the crystal structure of the apatite expressed by the above general formula as part of the metal atoms constituting the crystal structure, a catalytic partial structure which provides a catalytic function as a physical property of the entire crystal is formed in the apatite crystal structure. Specifically, the “catalytic partial structure” herein means a metal oxide structure consisting of a photocatalytic metal incorporated in place of part of A in the above formula and an oxygen atom in the formula, and which is necessary for providing the photocatalytic function as a physical property of the apatite structure.

According to the first aspect of the present invention, high antibacterial effect for storing food can be obtained both under normal conditions with light irradiation and in a dark place. As noted above, the metal-modified apatite used in the present invention includes a catalytic partial structure for providing a catalytic function in the apatite crystal structure and is capable of serving as a photocatalyst under conditions with light irradiation. Therefore, the metal-modified apatite kills e.g. bacteria adhering to a food container or decomposes the toxicity. Such antibacterial effect provided under conditions with light irradiation makes it possible to preserve food in the food container in good condition.

Further, the metal-modified apatite used in the present invention can provide the antibacterial effect also in a dark place. It is generally known that the substances such as titanium oxide (TiO₂) recognized as a photocatalytic substance exhibit the catalytic function only under light conditions, but not in a dark place. The inventor of the present invention found that, when titanium oxide (TiO₂) is combined with apatite, the combined substance exhibits the catalytic function for oxidative decomposition, which is similar to that of titanium oxide, not only under conditions with light irradiation but also in a dark place. More specifically, it was found that the same antibacterial effect as that of titanium oxide photocatalyst can be provided also in a dark place by using the metal modified apatite, which is a new material having both of the photocatalytic function originating from titanium oxide and the organic substance absorptivity and antibacterial function in a dark place originating from apatite. The present invention is based on this finding.

Moreover, in the metal-modified apatite of the present invention, the metal oxide structure which can provide a catalytic function in the physical property of the apatite is combined with the apatite crystal which is highly adsorptive. Therefore, such metal-modified apatite can serve as a catalyst having high adsorptivity. For example, in an instance of Ti-CaHAP provided by partially replacing Ca with Ti, titanium oxide capable of providing a catalytic function is combined with highly adsorptive CaHAP. Specifically, a partial structure of titanium oxide is formed in the CaHAP crystal structure. Therefore, Ti-CaHAP, having enhanced contact efficiency with the substance as the object of oxidative decomposition, can exhibit the catalytic function efficiently. The technique for such combination is also disclosed in JP-A-2000-327315, for example.

In this way, the metal-modified apatite according to the first aspect of the present invention has a high ability to adsorb organic substances such as bacteria or virus, functions effectively as a catalyst for e.g. oxidative decomposition not only under light conditions but in a dark place, and exhibits antibacterial function to deactivate bacteria or virus. Therefore, according to the first aspect of the present invention, good antibacterial effect in storing food can be obtained both under normal conditions with light irradiation and in a dark place.

According to a second aspect of the present invention, another food preserving method is provided. This method comprises wrapping food or a container containing food with a food wrapping film having a surface coated with a metal-modified apatite or with a food wrapping film made of a material to which the metal-modified apatite is added, the metal-modified apatite having an apatite crystal structure including metal atoms partially comprising photocatalytic metal, and placing the food or the container in a dark place at least temporarily.

According to a third aspect of the present invention, still another food preserving method is provided. This method comprises applying a metal-modified apatite to a surface of food or adding the metal-modified apatite to food, the metal-modified apatite having an apatite crystal structure including metal atoms partially comprising photocatalytic metal, and placing the food in a dark place at least temporarily.

According to a fourth aspect of the present invention, a method for keeping tableware is provided. This method comprises placing tableware having a surface coated with a metal-modified apatite or tableware made of a material to which the metal-modified apatite is added in a dark place at least temporarily, the metal-modified apatite having an apatite crystal structure including metal atoms partially comprising photocatalytic metal.

In the second through fourth aspects of the present invention again, use is made of the metal-modified apatite described with respect to the first aspect. Therefore, good antibacterial effect in storing food or tableware can be obtained both under normal conditions with light irradiation and in a dark place.

According to a fifth aspect of the present invention, a food container is provided which has an inner surface coated with a metal-modified apatite having an apatite crystal structure including metal atoms partially comprising photocatalytic metal.

According to a sixth aspect of the present invention, a food container is provided which is made of a material to which a metal-modified apatite is added, the metal-modified apatite having an apatite crystal structure including metal atoms partially comprising photocatalytic metal.

Preferably, the metal-modified apatite has a chemical structure obtained by replacing part of Ca contained in calcium hydroxyapatite with Ti. Calcium hydroxyapatite (Ti-CaHAP) modified by Ti has a partial structure which can exhibit the function to catalyze the oxidative decomposition of organic substances. Therefore, when Ti-CaHAP exhibits the catalytic function, bacteria or the toxicity is subjected to decomposition. Thus, when Ti-CaHAP is used as the metal-modified apatite in the present invention, the bactericidal effect as the antibacterial effect can be obtained.

Preferably, the metal-modified apatite after production has undergone sintering at 580 to 660° C. The inventor has confirmed that the catalytic effect of the metal-modified apatite can be improved by sintering the produced metal-modified apatite at 580 to 660° C. Therefore, the use of such metal-modified apatite for storing food, for example, provides the enhanced antibacterial effect and the bactericidal effect.

### BRIEF DESCRIPTION OF THE DRAWINGS

FIG. 1 illustrates a model of surface chemical structure of metal-modified apatite to be used in the present invention.

FIG. 2 is a flowchart showing the process for producing the metal-modified apatite to be used in the present invention.

FIG. 3 is a graph showing the antibacterial effect in Examples 1-4.

FIG. 4 is a graph showing the antibacterial effect in Comparative Examples 1 and 2.

### BEST MODE FOR CARRYING OUT THE INVENTION

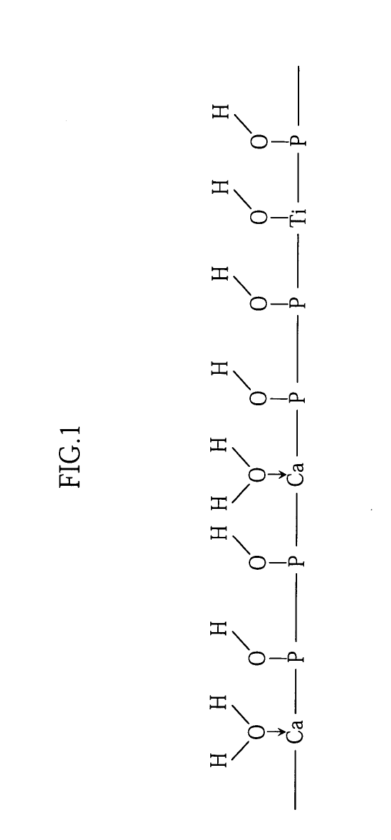

A metal-modified apatite used in the present invention is provided by combining a catalytic metal i.e., a metal which constitutes a metal oxide for effecting photocatalysis, and a so-called apatite at the atomic level. Examples of metal used for forming such a metal-modified a patite include titanium (Ti), zirconium (Zr), iron (Fe) and tungsten (W). As the apatite, use may be made of metal salt such as hydroxyapatite, fluoroapatite and chloroapatite. FIG. 1 illustrates the surface chemical structure of Ti-CaHAP, which is provided when Ti is selected as the metal and calcium hydroxyapatite is selected as the apatite.

As shown in FIG. 1, due to the incorporation of Ti, a catalytic partial structure, with Ti being the center, is formed in the crystal structure of Ti-CaHAP. The sites other than the partial structure have adsorption power which is generally equal to ordinary CaHAP. In this metal-modified apatite, the site for providing catalysis, i.e. the catalytic partial structure and an adsorptive site for adsorbing a particular substance (not shown) such as an organic substance are distributed on the same crystalline surface at the atomic level. Therefore, the metal-modified apatite is highly catalytic and highly adsorptive and is capable of efficiently performing the adsorption and decomposition of the object substance uniformly at the same time to efficient effect the catalysis.

In the present invention, to effectively enhance both of the adsorption power and the catalytic effect of the metal-modified apatite, it is preferable that the proportion of the catalytic metal relative to all of the metal atoms contained in the apatite crystal structure of the metal-modified apatite lies in the range of 3 to 11 mol %. Specifically, taking Ti-CaHAP as example, the value of Ti/(Ti+Ca) may preferably lie in the range of 0.03 to 0.11 (molar ratio). When the proportion is higher than 11 mol %, the distortion of the crystal structure may occur, so that a remarkable effect cannot be expected. The proportion lower than 3 mol % is not preferable, because with such a proportion, the substance adsorbed by adsorptive sites which are excessive in number cannot be sufficiently treated by the catalyst sites which are small in number, whereby the catalysis cannot be effected sufficiently.

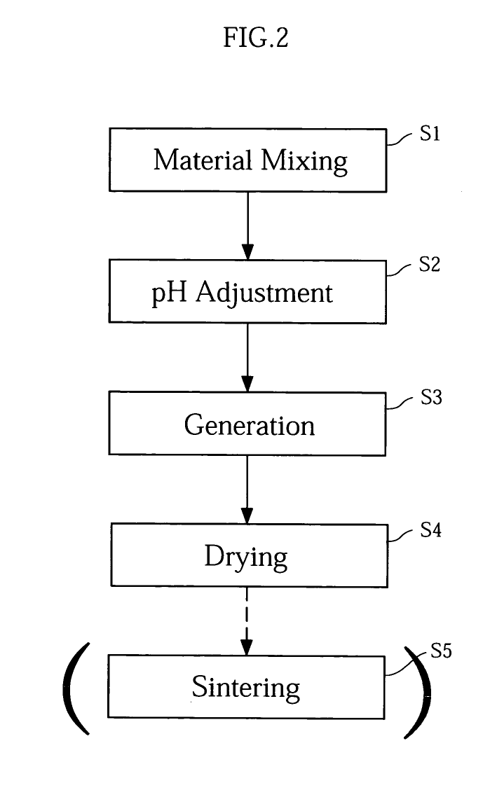

FIG. 2 is a flowchart showing how to produce the metal-modified apatite used for the food reserving method and food container of the present invention. To produce the metal-modified apatite, in a materiel mixing step S1, materials for producing the metal-modified apatite are mixed. For example, the chemical species corresponding to A, BO_{y}, X in the above-described general formula of apatite and catalytic metal ions are added to a single aqueous solution system each by a predetermined amount and mixed. When Ti-CaHAP is to be produced as the metal-modified apatite, use may be made of calcium nitrate as the Ca supplier. As the PO₄ supplier, use may be made of phosphoric acid. The hydroxyl group may be supplied from an alkaline solution to be used in the subsequent pH adjustment step, such as ammonia water, an aqueous solution of calcium hydroxide, or an aqueous solution of sodium hydroxide. As the supplier for supplying Ti as the catalytic metal, use may be made of titanium chloride or titanium sulfate.

As noted above, it is preferable that the proportion of catalytic metal atoms relative to all of the metal atoms contained in the apatite crystal structure lies in the range of 3 to 11 mol %. Preferably, therefore, in the material mixing step S1, the supply of each material is determined for adjusting the relative amount of the substances to be supplied so that the proportion of the catalytic metal atoms in the resulting metal-modified apatite lie in the range of 3 to 11 mol %.

Subsequently, in the pH adjustment step S2, the material solution prepared in the above manner is adjusted to a pH at which the reaction for producing the intended metal-modified apatite is initiated. For the pH adjustment, use may be made of an aqueous solution of ammonia, an aqueous solution of potassium hydroxide or an aqueous solution of sodium hydroxide. Preferably, the pH of the material solution may be adjusted to the range of 8 to 10. For example, also when a Ti-CaHAP coating as the metal-modified apatite coating is to be formed, it is preferable to adjust the pH of the material solution to the range of 8 to 10.

Subsequently, in a generation step S3, the generation of the metal-modified apatite is promoted for improving the crystallinity of the metal-modified apatite. Specifically, for example, the material solution, in which the catalytic metal and the apatite component have been partially coprecipitated, is subjected to aging at 100° C. for six hours, whereby highly crystalline metal-modified apatite can be obtained. For example, in producing Ti-CaHAP, Ti ions are incorporated into the apatite crystal structure at the location of Ca during the coprecipitation, whereby Ti-CaHAP grows.

Subsequently, in a drying step S4, the metal-modified apatite generated in the previous step is dried. Specifically, after the metal-modified apatite powder deposited in the generation step S3 is filtered, the precipitate separated out by filtration is washed with pure water and then dried. Preferably, the drying is performed at a temperature of 100 to 200° C. By this step, the liquid component in the material solution is removed from the metal-modified apatite.

The metal-modified apatite powder produced in this way is subjected to sintering in step S5 as required. In the sintering step S5, separately from the drying step S4, the metal-modified apatite is heated again for sintering. Preferably, the sintering is performed at a temperature of 580-660° C. For example, in the case of Ti-CaHAP, the catalytic function and the catalytic activity are enhanced by undergoing this step.

In embodying the present invention, the metal-modified apatite produced in the above-described manner is applied or fixed to a surface of a food storage container. The application or fixation of the metal-modified apatite is performed by means appropriate for the material of the container. Subsequently, fresh food or processed food is put into the container and stored in a dark place at least temporarily. Instead of applying or fixing the metal-modified apatite to a container surface, a food storage container may be made of e.g. a plastic material to which the metal-modified apatite is added, and food may be put in and stored in such a container.

In another embodiment of the present invention, the metal-modified apatite may be applied or fixed to a surface of tableware. The application or fixation of the metal-modified apatite is performed by means appropriate for the material of the tableware. The tableware is stored in a dark place at least temporarily. Instead of applying or fixing the metal-modified apatite to a tableware surface, tableware may be made of e.g. a plastic material to which the metal-modified apatite is added, and the tableware may be stored.

To apply or fix the metal-modified apatite to the surface of a food storage container or tableware, the metal-modified apatite powder is dispersed in a sol-gel solution containing silica alkoxide, for example. The dispersion is applied to the surface of the food storage container or tableware to form a coating containing the metal-modified apatite on the surface of the member. In coating, other inorganic or organic coating material may be used instead of the sol-gel solution.

In another embodiment of the present invention, the metal-modified apatite may be applied or fixed to the surface of processed food or fresh food. The application or fixation of the metal-modified apatite is performed by means appropriate for the food. The food is then stored in a dark place at least temporarily. Instead of applying or fixing the metal-modified apatite to the food surface, processed food may be made using a foodstuff to which the metal-modified apatite is added, and the processed food may be stored.

According to the present invention, in storing food or tableware, excellent antibacterial effect can be obtained not only under conditions with light irradiation but also in a dark place. Specifically, the catalytic function of the metal-modified apatite of the present invention makes it possible to kill the harmful bacteria adhered to the food container or tableware and decompose the dead bacteria or toxicity by e.g. oxidative decomposition both under conditions with light irradiation and under dark conditions. Therefore, the food contained in the container or the tableware can be kept fresh and clean, whereby food poisoning and the like can be avoided. The antibacterial effect is enhanced by using the metal-modified apatite which has undergone the sintering step.

Examples of the present invention will be described below along with comparative examples.

### EXAMPLE 1

(Preparation of Metal-Modified Apatite)

In this example, Ti-CaHAP was prepared as a metal-modified apatite. Specifically, 1 L of pure water having undergone decarboxylation was prepared, and calcium nitrate, titanium sulfate and phosphoric acid were added into the pure water and mixed. The concentration of calcium nitrate was 0.09 mol/L, the concentration of titanium sulfate was 0.01 mol/L, and the concentration of phosphoric acid was 0.06 mol/L. Subsequently, 15 mol/L of ammonia water was added to adjust the pH of the material solution to 9.0. The material solution was then subjected to aging at 100° C. for six hours. Through the above process, the generation and deposition of the metal-modified apatite proceeded in the material solution, whereby the material solution changed to a suspension. After the suspension was filtrated, the separated precipitate was washed with 5 L of pure water and then dried in a dry oven at 70° C. for 12 hours. In this way, minute particles of Ti-CaHAP as the metal-modified apatite of this example was obtained. The ratio of Ti to Ca in Ti-CaHAP thus obtained was 1:9. That is, the proportion of Ti atoms as the catalytic metal atoms in all of the metal atoms contained in the crystal structure of the metal-modified apatite was 10 mol %. The ratio of Ti to Ca was identified based on the quantitative analysis utilizing the ICP-AES (plasma emission spectrometry).

(Antibacterial Effect Test)

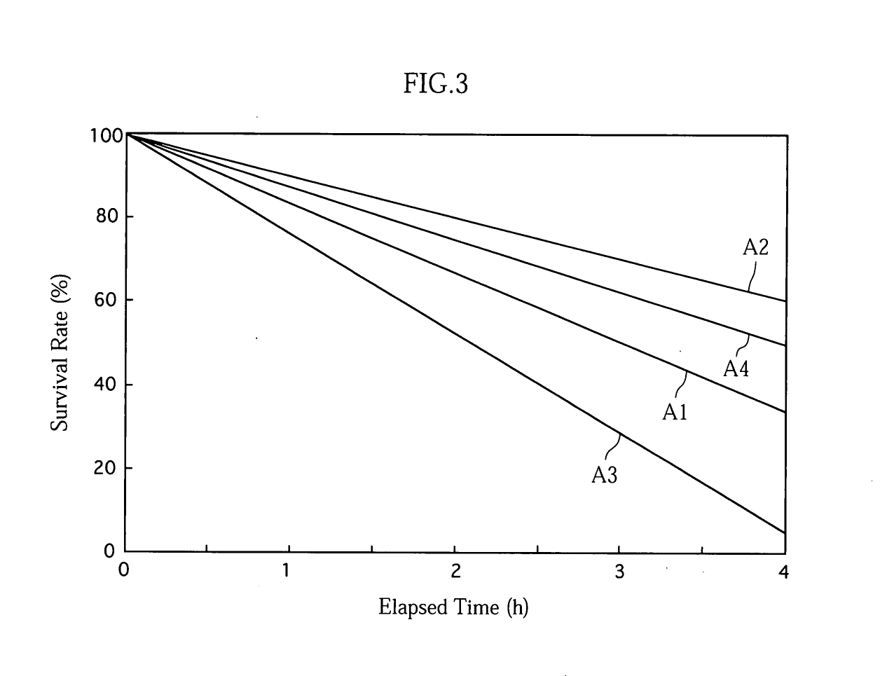

The antibacterial effect of the metal-modified apatite prepared in the above-described manner was checked. Specifically, minute particles of metal-modified apatite were uniformly dispersed in silica alkoxide as a solvent to prepare a coating solution. The concentration of the metal-modified apatite in the coating solution was 1 wt %. Subsequently, the coating solution was uniformly applied onto a 50×50 mm glass plate by spin coating and then dried, whereby a coating containing the metal-modified apatite and having a thickness of about 1 to 2 μm was formed on the glass plate. Subsequently, after a drop of liquid colon bacillus culture was placed onto the coating containing the metal-modified apatite, the glass plate was left at 25° C., with the dropped portion irradiated with ultraviolet rays (<300 nm). After a predetermined time had elapsed since the starting of the ultraviolet irradiation, the number of Colon bacilli existing on the apatite-containing coating was measured at a plurality of time points, whereby the survival rate of Colon bacilli relative to the initial number was figured out. Based on the plot in which the abscissa represents elapsed time whereas the ordinate represents the survival rate of Colon bacilli, the graph A1 shown in FIG. 3 was obtained.

### EXAMPLE 2

A coating containing metal-modified apatite was formed on a 50×50 mm glass plate in the same manner as in Example 1 by using minute particles of the same metal-modified apatite as that of Example 1. With respect to the coating containing the metal-modified apatite, the antibacterial effect was checked in the same manner as in Example 1, except that the glass plate was left in a dark place without performing ultraviolet irradiation. Based on the plot in which the abscissa represents elapsed time whereas the ordinate represents the survival rate of Colon bacilli, the graph A2 shown in FIG. 3 was obtained.

### EXAMPLE 3

Minute particles of the same metal-modified apatite as that of Example 1 was sintered at 650° C. for 30 minutes. By using this metal-modified apatite particles, a coating containing the metal-modified apatite was formed on a 50×50 mm glass plate in the same manner as in Example 1. With respect to the coating containing the metal-modified apatite, the antibacterial effect was checked in the same manner as in Example 1. Based on the plot in which the abscissa represents elapsed time whereas the ordinate represents the survival rate of Colon bacilli, the graph A3 shown in FIG. 3 was obtained.

### EXAMPLE 4

A coating containing metal-modified apatite was formed on a 50×50 mm glass plate in the same manner as in Example 1 by using minute particles of the same metal-modified apatite as that of Example 3. With respect to the coating containing the metal-modified apatite, the antibacterial effect was checked in the same manner as in Example 1, except that the glass plate was left in a dark place without performing ultraviolet irradiation. Based on the plot in which the abscissa represents elapsed time whereas the ordinate represents the survival rate of Colon bacilli, the graph A4 shown in FIG. 3 was obtained.

[Comparative Example 1]

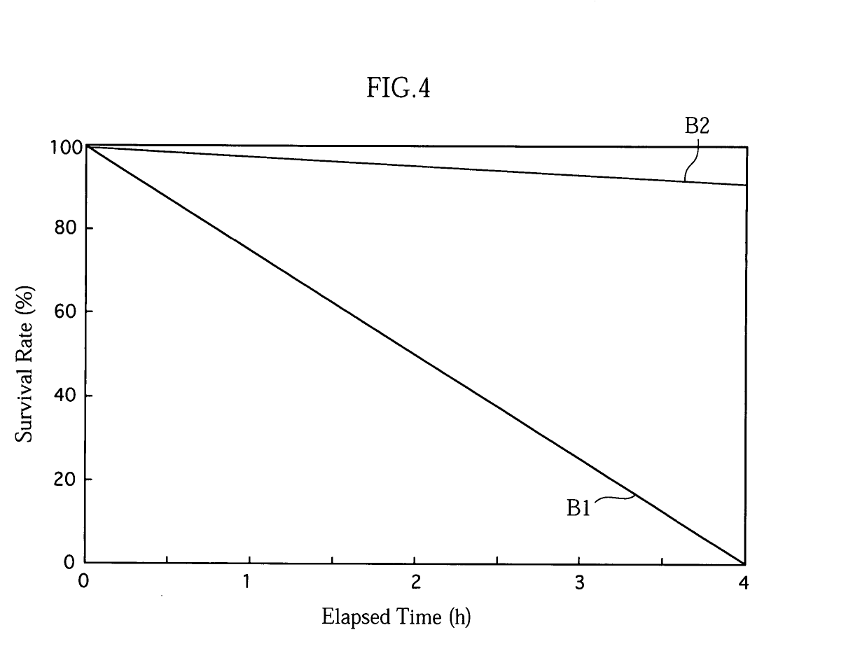

Minute particles of photocatalytic titanium oxide (Tradename: ST21, Manufactured by Ishihara Sangyo Kaisha, Ltd.) were uniformly dispersed in silica alkoxide as a solvent to prepare a coating solution. The concentration of titanium oxide particles in the coating solution was 1 wt %. Subsequently, the coating solution was uniformly applied onto a 50×50 mm glass plate by spin coating and then dried, whereby a coating containing titanium oxide and having a thickness of about 1 to 2 μm was formed on the glass plate. Subsequently, after a drop of liquid colon bacillus culture was placed onto the coating, the glass plate was left at 25° C., with the dropped portion irradiated with ultraviolet rays (<300 nm). After a predetermined time had elapsed since the starting of the ultraviolet irradiation, the number of Colon bacilli existing on the titanium oxide-containing coating was measured at a plurality of time points, whereby the survival rate of Colon bacilli relative to the initial number was figured out. Based on the plot in which the abscissa represents elapsed time whereas the ordinate represents the survival rate of Colon bacilli, the graph B1 shown in FIG. 4 was obtained.

### COMPARATIVE EXAMPLE 2

A coating containing titanium oxide was formed on a 50×50 mm glass plate in the same manner as in Comparative Example 1 by using minute particles of the same titanium oxide as that of Comparative Example 1. With respect to the titanium oxide-containing coating, the antibacterial effect was checked in the same manner as in Comparative Example 1, except that the glass plate was left in a dark place without performing ultraviolet irradiation. Based on the plot in which the abscissa represents elapsed time whereas the ordinate represents the survival rate of Colon bacilli, the graph B2 shown in FIG. 4 was obtained.

[Evaluation of Antibacterial Effect]

As shown in the graphs of FIGS. 3 and 4, the survival rate of Colon bacilli four hours after the leaving of the coating had started was 35% in Example 1, 60% in Example 2, 5% in Example 3, 50% in Example 4, 0% in Comparative Example 1 and 90% in Comparative Example 2.

As will be understood from these results, Examples 1-4 which used the metal-modified apatite of the present invention exhibit excellent antibacterial effect both under light conditions and dark conditions. This is because, the metal-modified apatite used in the present invention effected significant degree of catalysis both under light conditions and dark conditions. Further, Examples 3 and 4 which used the sintered metal-modified apatite exhibit the antibacterial effect which is higher than that of Examples 1 and 2 which used non-sintered metal-modified apatite. This is because, the crystallinity of the metal-modified apatite is improved by sintering, whereby the catalytic effect is enhanced.

As will be understood from Comparative Examples 1 and 2, when titanium oxide is used instead of the metal-modified apatite, the antibacterial effect is hardly obtained under conditions without light (ultraviolet) irradiation. Conceivably, this is because, titanium oxide functions only as photocatalyst which utilizes the energy of light as a driving source and does not function in a dark place.

1. A method for preserving food comprising: putting food in a container having an inner surface coated with a metal-modified apatite or in a container made of a material to which the metal-modified apatite is added, the metal-modified apatite having an apatite crystal structure including metal atoms partially comprising photocatalytic metal; and placing the container in a dark place at least temporarily.

2. The method for preserving food according to claim 1, wherein the metal-modified apatite has a chemical structure obtained by replacing part of Ca contained in calcium hydroxyapatite with Ti.

3. The method for preserving food according to claim 1, wherein the metal-modified apatite after production has undergone sintering at 580 to 660° C.

4. A method for preserving food comprising: wrapping food or a container containing food with a food wrapping film having a surface coated with a metal-modified apatite or with a food wrapping film made of a material to which the metal-modified apatite is added, the metal-modified apatite having an apatite crystal structure including metal atoms partially comprising photocatalytic metal; and placing the food or the container in a dark place at least temporarily.

5. The method for preserving food according to claim 4, wherein the metal-modified apatite has a chemical structure obtained by replacing part of Ca contained in calcium hydroxyapatite with Ti.

6. The method for preserving food according to claim 4, wherein the metal-modified apatite after production has undergone sintering at 580 to 660° C.

7. A method for preserving food comprising: applying a metal-modified apatite to a surface of food or adding the metal-modified apatite to food, the metal-modified apatite having an apatite crystal structure including metal atoms partially comprising photocatalytic metal; and placing the food in a dark place at least temporarily.

8. The method for preserving food according to claim 7, wherein the metal-modified apatite has a chemical structure obtained by replacing part of Ca contained in calcium hydroxyapatite with Ti.

9. The method for preserving food according to claim 7, wherein the metal-modified apatite after production has undergone sintering at 580 to 660° C.

10. A method for keeping tableware comprising: placing tableware having a surface coated with a metal-modified apatite or tableware made of a material to which the metal-modified apatite is added in a dark place at least temporarily, the metal-modified apatite having an apatite crystal structure including metal atoms partially comprising photocatalytic metal.

11. The method for keeping tableware according to claim 10, wherein the metal-modified apatite has a chemical structure obtained by replacing part of Ca contained in calcium hydroxyapatite with Ti.

12. The method for keeping tableware according to claim 10, wherein the metal-modified apatite after production has undergone sintering at 580 to 660° C.

13. A food container having an inner surface coated with a metal-modified apatite having an apatite crystal structure including metal atoms partially comprising photocatalytic metal.

14. A food container made of a material to which a metal-modified apatite is added, the metal-modified apatite having an apatite crystal structure including metal atoms partially comprising photocatalytic metal.
